(19) United States
(12) Patent Application Publication
(10) Pub. No.: US 2011/0196573 A1
(43) Pub. Date: Aug. 11, 2011

(54) METHOD OF CONTROLLING INVERTER-INTEGRATED ELECTRIC COMPRESSOR FOR VEHICULAR AIR CONDITIONING SYSTEM

(75) Inventors: Geon Ho Lee, Gyeonggi-do (KR); In Hwe Koo, Gyeonggi-do (KR); Jung Kyung Lee, Gyeonggi-do (KR)

(73) Assignees: DOOWON TECHNICAL COLLEGE, ANSEONG-SHI, KYONGGI-DO (KR); DOOWON ELECTRONIC CO., LTD, ASAN-SHI, CHUNGNAM (KR)

(21) Appl. No.: 13/057,754

(22) PCT Filed: Jul. 31, 2009
(86) PCT No.: PCT/KR09/04310

§ 371 Date: Apr. 25, 2011

(30) Foreign Application Priority Data
Aug. 6, 2008 (KR) 10-2008-0076910

(51) Int. Cl. B60H 1/32

(52) U.S. Cl. 701/36

(57) ABSTRACT

Disclosed is a method of controlling an inverter-integrated electric compressor for a vehicular air conditioning system, which prevents an over-current from being generated due to a load of an inverter for driving the electric compressor and reduces an RPM even without stopping the vehicular air conditioning system, preventing damage to the air conditioning system due to an over-current. The method of controlling an inverter-integrated electric compressor for a vehicular air conditioning system includes the steps of: (1) calculating a target RPM of a motor for driving the inverter-integrated electric compressor in a vehicular air conditioning system; (2) checking whether a current applied to the motor driven according to the target RPM exceeds a threshold value preset in the inverter; and (3) decreasing, if the current applied to the motor exceeds the threshold vale, the target RPM in the inverter to perform a feedback control of reducing the current, and rotating, if the current applied to the motor does not exceed the threshold value, the motor according to the target RPM.

### TECHNICAL FIELD

The present invention relates to a method of controlling an inverter-integrated electric compressor for a vehicular air conditioning system, and more particularly to a method of controlling an inverter-integrated electric compressor for a vehicular air conditioning system that prevents an over-current from being generated due to a load of an inverter for driving the electric compressor and reduces an RPM even without stopping the vehicular air conditioning system, preventing damage to the air conditioning system due to an over-current.

### BACKGROUND ART

In general, a vehicular air conditioning system is a system adapted to introduce air from the outside or an interior of a vehicle to heat or cool the introduced air, and blow the heated or cooled air into the interior of the vehicle to heat or cool the interior of the vehicle.

In more detail, a technology relating only to a cooling operation will be described herein. As shown in FIG. 1, a cooling operation of a vehicular air conditioning system 1 is as follows.

First, if a refrigerant compressed by an electric compressor 12 configured to receive power of an engine (not shown) to be driven is introduced into a condenser 14, it is heat-exchanged and condensed by compulsory blowing of a cooling fan (not shown), and then passes through a receiver driver 16, an expansion valve 18, and an evaporator 20 in order.

In this case, in a process of reintroducing the refrigerant into the electric compressor 12, air blown by a blower fan 24 of a blower unit 22 is heat-exchanged with the refrigerant passing through the evaporator 20 and is introduced into the interior of the vehicle in a cooled state, cooling the interior of the vehicle.

In this case, there are installed a defrost vent 36 for removing frost produced on front glass of the vehicle, a face vent 38 for blowing air to the upper side of the interior of the vehicle, and a foot vent 40 for blowing air to the lower side of the interior of the vehicle.

The vents 36, 38, 40 are opened and closed according to selection of modes by a user, and doors 42, 44, and 46 rotatable by predetermined angles by actuators are installed for this purpose such that opened/closed states and opening degrees of the vents 36, 38, and 30 are regulated according to selection of a user.

An exterior air inlet 28 and an exterior air outlet 30 are formed in the vehicular air conditioning system 1 on opposite sides of an upper end of a blower case 26 of the blower unit 22 such that they are selectively opened and closed as a conversion door 32 is rotated according to selection of a user as to whether air required for air conditioning is introduced from the interior of the vehicle or from the outside of the vehicle.

Meanwhile, a motor 50 provided separately from a main power motor (not shown) for driving the vehicle should be used to drive the electric compressor 12, and is controlled by an inverter 60 such that the speed of the vehicle can be increased or decreased according to a load applied thereto.

In this case, the inverter 60 is adapted to convert an AC current serving as a current source to a DC current to drive a 3-phase motor 50, and a main element of the inverter 60 is a semiconductor which may be damaged by heat generated during a switching operation of the inverter 60 for control.

Thus, the inverter 60 needs to be continuously cooled during the operation of the motor 12 to be prevented from malfunctioning by heat. To achieve this, a technology of attaching a heat radiating plate on one side of the inverter 60 or stopping a driving operation of the electric compressor 12 when a drivable torque value of the motor 50 is exceeded is mainly used.

However, in the case of a heat radiating plate for cooling an inverter, since the area of the heat radiating plate is increased to sufficiently cool the inverter of a high temperature, the entire size and number of parts increase, increasing manufacturing and other costs. In addition, when a driving operation of an electric compressor is stopped, although the inverter is protected from an over-current and heat, a cooling efficiency is rapidly lowered and cooling of the vehicle is stopped at the same time when the driving operation of the electric compressor is stopped.

### DISCLOSURE

### Technical Problem

Therefore, it is an object of the present invention to provide a method of controlling an inverter-integrated electric compressor for a vehicular air conditioning system which reduces an RPM of an electric compressor without stopping an operation of the electric compressor when a high load is applied to the electric compressor, thereby preventing damage to the electric compressor due to an over-current.

It is another object of the present invention to provide a method of controlling an inverter-integrated electric compressor for a vehicular air conditioning system which maintains a maximum rated output of a motor configured to drive an electric compressor to continuously maintain a cooled state and prevent a cooling operation of a vehicle from being rapidly deteriorated, increasing a feeling quality of a user.

It is still another object of the present invention to provide a method of controlling an inverter-integrated electric compressor for a vehicular air conditioning system which reduces an RPM of a motor to limit a current with an over-current being applied to a motor, preventing the motor from being stopped, and reduces power consumption, without requiring a power for motivating the motor due to stopping of the motor, increasing a power efficiency.

### Technical Solution

In order to achieve the above-mentioned objects, there is provided a method of controlling an inverter-integrated electric compressor for a vehicular air conditioning system, the method comprising the steps of: (1) calculating a target RPM of a motor for driving the inverter-integrated electric compressor in a vehicular air conditioning system; (2) checking whether a current applied to the motor driven according to the target RPM exceeds a threshold value preset in the inverter; and (3) decreasing, if the current applied to the motor exceeds the threshold vale, the target RPM in the inverter to perform a feedback control of reducing the current, and rotating, if the current applied to the motor does not exceed the threshold value, the motor according to the target RPM.

Preferably, the method further includes: updating, after the step (3), an interior temperature and determining whether the updated interior temperature reaches a set temperature in the control unit, and returning to the step (1) to perform the control method until the interior temperature reaches the set temperature.

Preferably, in decreasing the target RPM in the step (3), the inverter calculates a decreased RPM using a value obtained by multiplying the target RPM of the step (1) by a pre-stored setting rate.

Preferably, the setting rate is differentially applied according to the difference between the current applied to the motor and the threshold value.

Preferably, the setting rate has a unit of % and is set to be less than 100.

Preferably, the method further includes: increasing the target RPM within a range where a rated output of the motor is exceeded when the motor is rotated at a low RPM in a high torque region such that the RPM of the motor does not approach the target RPM.

According to the present invention, in the case where a high load is applied to a motor configured to drive an electric compressor of a vehicular air conditioning system when the electric compressor is driven, only an RPM of the motor is reduced with a maximum rated output and a torque of the motor being maintained, making it possible to prevent damage to the motor due to an over-current and secondary damage to the electric compressor and an inverter. Also, when an over-current is applied, an output power is reduced with the inverter not being stopped, making it possible to prevent the electric compressor being stopped due to the over-current and a surge voltage. Accordingly, a cooled state can be continuously maintained and a power consumption efficiency can be increased.

### DESCRIPTION OF DRAWINGS

FIG. 1 is a diagram schematically illustrating a general vehicular air conditioning system;

FIG. 2 is a block diagram schematically illustrating a vehicular air conditioning system according to an embodiment of the present invention; and

FIG. 3 is a flowchart schematically illustrating a method of controlling an inverter-integrated electric compressor for a vehicular air conditioning system according to the embodiment of the present invention.

### MODE FOR INVENTION

Hereinafter, an exemplary embodiment of the present invention will be described in detail with reference to the accompanying drawings.

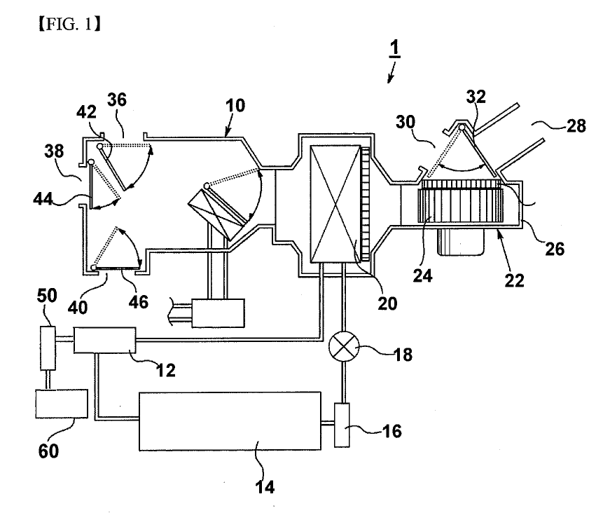

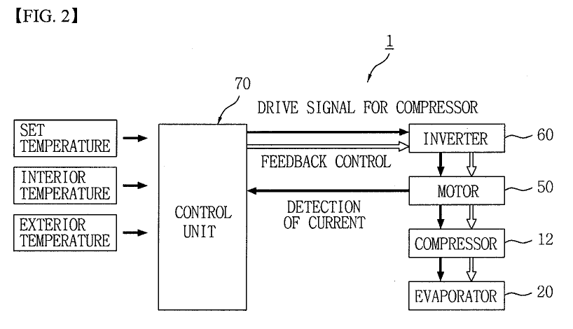

FIG. 2 is a block diagram schematically illustrating a vehicular air conditioning system according to an embodiment of the present invention, which is illustrated with reference to FIG. 1.

As shown in FIGS. 1 and 2, in the vehicular air conditioning system 1 according to the embodiment of the present invention, if an air conditioner of a vehicle is switched ON and a temperature set by a user is input to a control unit 70, interior and exterior temperatures of the vehicle measured by an interior temperature sensor and an exterior temperature sensor are input to the control unit 70.

Then, the control unit 70 calculates a difference between a desired temperature set by a user and the interior temperature of the vehicle, and determined whether or not an electric compressor 12 should be driven.

In this case, when a temperature in a duct needs to be lowered by driving the electric compressor 12, a signal for driving the electric compressor 12 is transmitted from the control unit 70 to an inverter 60 where DC power produced by power of an engine is converted to AC power and is transferred to a motor 50 of the electric compressor 12.

The motor 50 drives a drive shaft (not shown) to drive the electric compressor 12 using the AC power output from the inverter 60, and a refrigerant compressed by an operation of the electric compressor 12 passes through a condenser 14, a receiver driver 16, an expansion valve 18, and an evaporator 20 in order to lower the temperature in the duct.

Thus, the cool air in the duct is transferred into the interior of the vehicle through vents 36, 38, and 40 by a blower fan 24 of a blower unit 22.

In this case, a circulation process of compression, expansion, and evaporation is continuously repeated until the interior temperature of the vehicle reaches the temperature set by the user. Then, if a difference between the set temperature and the interior temperature of the vehicle is large, since a load applied to a motor 50 configured to drive the electric compressor 12 is large, the inverter 60 should regulate the magnitude of the current applied to the motor 50.

That is, if a load higher than a maximum output of the motor 50 is applied, the motor 50 is driven at an excessive output such that the interior temperature of the vehicle reaches the set temperature, being damaged. In this case, the motor 50 may be damaged due to an over-current caused by the semiconductor of the inverter 60.

Thus, the motor 50 does not generate an output proportional to a load applied to it. Instead, in the vehicular air conditioning system 1, a motor driving driver (not shown) and the control unit 70 detect a driving current applied to the motor 50 to feedback-control the motor 50 such that an output of the motor 50 does not exceed the maximum output of the motor 50.

Meanwhile, according to the present invention, an output of the motor 50 is controlled by the control unit 70 of the vehicular air conditioning system and is also feedback-controlled by the inverter 60 configured to determine generation of an over-current. That is, although FIG. 2 illustrates that control is executed only by the control unit 70, but the present invention is not limited thereto but the inverter 60 itself determines generation of an over-current and feedback-controls the system.

Accordingly, if a current applied to the motor 50 is detected by the control unit 70 or the inverter 60, an output is calculated based on the detected current, in which case if the calculated output exceeds a maximum output of the motor 50, an RPM of the motor 50 is reduced according to Equation 1 so as not to exceed the maximum output of the motor 50.

P=τ·ω Equation 1

where P is an output (W), τ is a torque (Nm), and ω is an angular velocity (rad/sec).

According to the present invention, since a method of reducing an RPM of a motor 50 to maintain a rated voltage is applied to the vehicular air conditioning system 1, an angular velocity (ω) is converted to an RPM (n), resulting in Equation 2.

ω=n

ω=n[rev/min]

ω=n[rev/min]·[2π·rad]/[rev]·[min/60 sec]

∴P=τ·n·2π/60 Equation 2

Thus, since if an RPM (n) of the motor 50 is lowered while maintaining a torque (τ) of the motor 50, only a speed of the motor 50 is reduced with a rotating force not being reduced, when a rated power is exceeded, a power efficiency can be relatively increased than in the case of stopping the inverter 60.

Thereafter, the control unit 70 drives the motor 50 to continuously perform a heat absorbing process in the electric compressor 12, the condenser 14, the expansion valve 18, and the evaporator 20 until a difference between a temperature set by a user and a interior temperature of the vehicle becomes within a preset error range.

In this case, if the difference between a temperature set by a user and a interior temperature of the vehicle is reduced within a preset error range, the control unit 70 stops driving of the vehicular air conditioning system 1. Then, in the case of a manually operated air conditioner, if a user input a set temperature, or in the case of automatic air conditioner (FATC), if the difference between a temperature set by a user and a interior temperature of the vehicle is deviated from a preset error range, a process of controlling the electric compressor 12 according to the present invention is performed.

Preferably, the present invention further includes a process of increasing a target RPM within a range where a rated output of the motor 50 is not exceeded when the motor rotates at a low RPM in a high torque region so as not to reach the target RPM.

Through the above-described control, the vehicular air conditioning system 1 can be continuously driven to provide a user with a comfortable environment. Then, in the case of an electric compressor 12 where an inverter 60 is integrated, a danger factor can be reduced, allowing stable driving of the electric compressor 12.

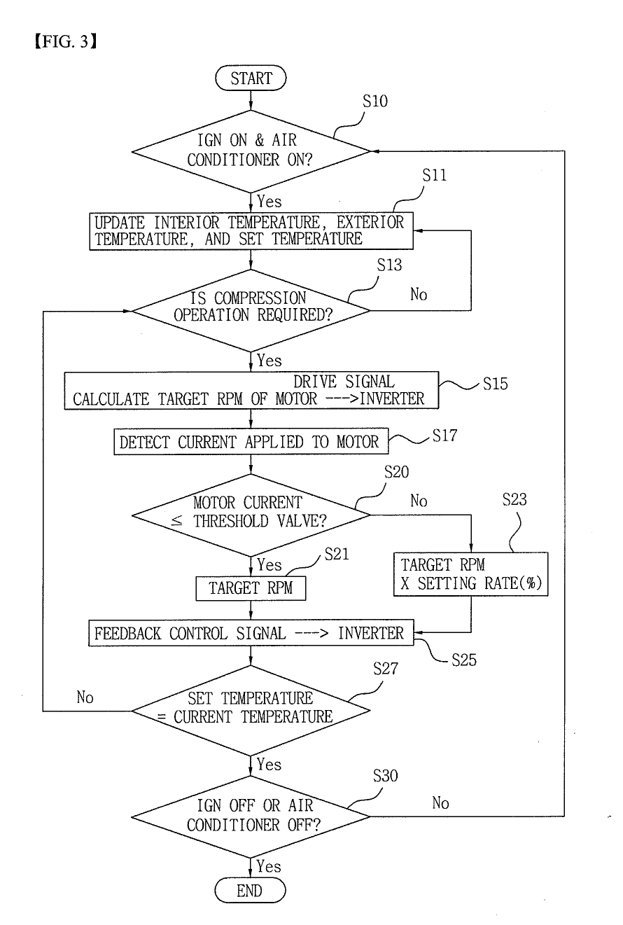

FIG. 3 is a flowchart schematically illustrating a method of controlling an inverter-integrated electric compressor for a vehicular air conditioning system according to the embodiment of the present invention. As shown in FIG. 3, the method of controlling an inverter-integrated electric compressor for a vehicular air conditioning system according to the embodiment of the present invention is started when a user switches on an air conditioner with ignition being ON (IGN ON) (S10).

In the step (S10), ignition is turned on and power of the battery is supplied to the air conditioner, and if a driving operation of the air conditioner is started, the control unit of the air conditioner updates current interior and exterior temperatures and receives a temperature set by a user (S11).

Thereafter, the control unit calculates a difference between an interior temperature and a set temperature. If the difference between an interior temperature and a set temperature is within an error range, the air conditioner is not driven, and if the difference between an interior temperature and a set temperature is deviated from the error range, the air conditioner is driven. In the process, the control unit determines whether the electric compressor is to be driven or not.

Thus, if the electric motor needs to be driven (S13), a target RPM of the motor for driving the electric compressor is calculated and a drive signal is output to the inverter to drive the motor (S15), and if the inverter applies a current according to a target RPM to the motor, the motor driver or the control unit detects the current applied to the motor (S17).

The step (S17) is performed to prevent secondary damage to the electric compressor and the inverter as well as damage to the motor due to an over-current or a surge current applied to the inverter, and it is determined whether an over-current is applied or not depending on whether a threshold current stored in the control unit or the inverter in advance is exceeded or not (S20).

Thus, when the current applied to the motor does not exceed a threshold value in the step (S20), the control unit or the inverter rotates the motor at a target RPM calculated in the step (S15), and if the current applied to the motor exceeds the threshold value, a setting rate less than 100% is applied to the target RPM calculated in the step (S15) to rotate the motor, in which case the target RPMs in these cases are output to the control unit or the inverter using a feedback control signal (S25).

Since the rated output of the motor is a fixed value, the setting rate of the step (S23) is set to reduce the RPM according to the magnitude of the exceeded current. Accordingly, the setting rate according to the magnitude of the exceeded current is tabled in the inverter itself to be stored in advance.

That is, a setting rate is set such that the larger the exceeded current is, the larger the reduction width of the RPM is.

If a difference between a set temperature and a current temperature exceeds a preset temperature range, the control unit determines that the air conditioner should be continuously driven and returns to the step (s13) to drive the vehicular air conditioning system according to the present invention until the error range is reduced, and if the current temperature is close to the set temperature, the step returns to the step (S10) to apply the method of controlling an electric compressor according to the present invention until ignition or the air conditioner is turned off.

Finally, if ignition is turned off such that no power is supplied from the battery or the air conditioner is turned off by a user, the method of controlling an inverter-integrated electric compressor for a vehicular air conditioning system according to the present invention is completed (S30).

Preferably, if the process is proceeded and a target RPM is lowered in a high torque region, a process of increasing the target RPM as long as a rated output of the motor is not exceeded and an over-current is not generated may be further included.

In the method of controlling an inverter-integrated electric compressor for a vehicular air conditioning system according to the present invention, the inverter may not be stopped even when a high load is applied, and hence a secondary damage of the elements by an over-current and a surge voltage can be prevented. In addition, since a motive power for driving the electric compressor with the electric compressor being stopped is not required, a power efficiency can be increased.

While the invention has been shown and described with reference to certain exemplary embodiments thereof, it will be understood by those skilled in the art that various changes in form and details may be made therein without departing from the spirit and scope of the invention as defined by the appended claims.

### INDUSTRIAL AVAILABILITY

According to the present invention, when an over-current is applied from an inverter to a motor due to an increase in a compression load, an electric compressor cannot be stopped due to an over-current by reducing an RPM while maintaining a rated output and a torque of the motor. Accordingly, a cooled state can be continuously maintained, increasing a feeling quality of a user. In addition, since a motive power is not required when the motor is stopped and driven again, a power efficiency can be increased by reducing power consumption.

1. A method of controlling an inverter-integrated electric compressor for a vehicular air conditioning system, the method comprising the steps of:
(1) calculating a target RPM of a motor for driving the inverter-integrated electric compressor in the vehicular air conditioning system;
(2) checking whether a current applied to the motor driven according to the target RPM exceeds a threshold value preset in the inverter; and
(3) decreasing, if the current applied to the motor exceeds the threshold vale, the target RPM in the inverter to perform a feedback control of reducing the current, and rotating, if the current applied to the motor does not exceed the threshold value, the motor according to the target RPM.

2. The method as claimed in claim 1, further comprising: updating, after the step (3), an interior temperature and determining whether the updated interior temperature reaches a set temperature in a control unit, and returning to the step (1) to perform the control method until the interior temperature reaches the set temperature.

3. The method as claimed in claim 2, wherein in decreasing the target RPM in the step (3), the inverter calculates a decreased RPM using a value obtained by multiplying the target RPM of the step (1) by a pre-stored setting rate.

4. The method as claimed in claim 3, wherein the setting rate is differentially applied according to the difference between the current applied to the motor and the threshold value.

5. The method as claimed in claim 4, wherein the setting rate has a unit of % and is set to be less than 100.

6. The method as claimed in claim 1, further comprising: increasing the target RPM within a range where a rated output of the motor is exceeded when the motor is rotated at a low RPM in a high torque region such that the RPM of the motor does not approach the target RPM.
